(19) United States
(12) Patent Application Publication
(10) Pub. No.: US 2025/0190485 A1
(43) Pub. Date: Jun. 12, 2025

(54) VERIFICATION APPARATUS, VERIFICATION METHOD, AND RECORDING MEDIUM

(71) Applicant: NEC Corporation, Minato-ku, Tokyo (JP)

(72) Inventor: Takaya MIYAMOTO, Tokyo (JP)

(73) Assignee: NEC Corporation, Minato-ku, Tokyo (JP)

(21) Appl. No.: 18/844,468

(22) PCT Filed: Mar. 14, 2022
(86) PCT No.: PCT/JP2022/011346

§ 371 Date: Sep. 6, 2024

(51) Int. Cl. G06F 16/532; G06F 16/535

(52) U.S. Cl. CPC G06F 16/532; G06F 16/535

(57) ABSTRACT

A verification apparatus includes: a verification unit that extracts a plurality of pieces of first similar data similar to query data, from a plurality of pieces of registration data, on the basis of a query feature quantity that is a feature quantity of the query data; and a correction unit that corrects the query feature quantity on the basis of an arithmetic value of a plurality of registration feature quantities that are feature quantities of the plurality of pieces of first similar data, wherein the verification unit extracts at least one piece of second similar data similar to the query data, from the plurality of pieces of registration data, on the basis of the query feature quantity corrected by the correction unit.

### TECHNICAL FIELD

This disclosure relates to, for example, technical fields of a verification apparatus, a verification method, and a recording medium that are configured to extract similar data that are similar to query data, from a plurality of pieces of registration data, by collating/verifying the query data with the plurality of pieces of registration data.

### BACKGROUND ART

Patent Literature 1 describes an example of the verification apparatus that is configured to collate/verify the query data with the plurality of pieces of registration data. In addition, as prior art literatures related to this disclosure, Patent Literatures 2 to 3 are cited.

### CITATION LIST

### Patent Literature

Patent Literature 1: JP2003-346149A
Patent Literature 2: JP2009-031991A
Patent Literature 3: JP2015-018401A

### Non-Patent Literature

Non-Patent Literature 1: Zhun Zhong et. al, “Re-ranking Person Re-identification with k-reciprocal Encoding”, arXiv 1701.08398, 5 May 2017

### SUMMARY

### Technical Problem

It is an example object of this disclosure to provide a verification apparatus, a verification method, and a recording medium that are intended to improve the techniques/technologies described in Citation List.

### Solution to Problem

A verification apparatus according to an example aspect of this disclosure includes: a verification unit that extracts a plurality of pieces of first similar data similar to query data, from a plurality of pieces of registration data, on the basis of a query feature quantity that is a feature quantity of the query data; and a correction unit that corrects the query feature quantity on the basis of an arithmetic value of a plurality of registration feature quantities that are feature quantities of the plurality of pieces of first similar data, wherein the verification unit extracts at least one piece of second similar data similar to the query data, from the plurality of pieces of registration data, on the basis of the query feature quantity corrected by the correction unit.

A verification method according to an example aspect of this disclosure includes: extracting a plurality of pieces of first similar data similar to query data, from a plurality of pieces of registration data, on the basis of a query feature quantity that is a feature quantity of the query data; correcting the query feature quantity on the basis of an arithmetic value of a plurality of registration feature quantities that are feature quantities of the plurality of pieces of first similar data; and extracting at least one piece of second similar data similar to the query data, from the plurality of pieces of registration data, on the basis of the query feature quantity corrected.

A recording medium according to an example aspect of this disclosure is a recording medium on which a computer program that allows a computer to execute a verification method is recorded, the verification method including: extracting a plurality of pieces of first similar data similar to query data, from a plurality of pieces of registration data, on the basis of a query feature quantity that is a feature quantity of the query data; correcting the query feature quantity on the basis of an arithmetic value of a plurality of registration feature quantities that are feature quantities of the plurality of pieces of first similar data; and extracting at least one piece of second similar data similar to the query data, from the plurality of pieces of registration data, on the basis of the query feature quantity corrected.

### BRIEF DESCRIPTION OF DRAWINGS

FIG. 1 is a block diagram illustrating a configuration of a verification apparatus in a first example embodiment.

FIG. 2 schematically illustrates a query image, a plurality of registration images, and at least one similar image.

FIG. 3 schematically illustrates a query image, a plurality of registration images, and at least one similar image.

FIG. 4 is a block diagram illustrating a configuration of a verification apparatus in a second example embodiment.

FIG. 5 is a flowchart illustrating a flow of a verification operation performed by the verification apparatus in the second example embodiment.

FIG. 6 schematically illustrates a query image, a plurality of registration images, and at least one similar image.

### DESCRIPTION OF EXAMPLE EMBODIMENTS

Hereinafter, with reference to the drawings, a verification apparatus, a verification method, and a recording medium according to example embodiments will be described.

### (1) First Example Embodiment

First, a verification apparatus, a verification method, and a recording medium in a first example embodiment will be described. With reference to FIG. 1, the following describes the verification apparatus, the verification method, and the recording medium in the first example embodiment, by using a verification apparatus 1000 to which the verification apparatus, the verification method, and the recording medium in the first example embodiment are applied. FIG. 1 is a block diagram illustrating a configuration of the verification apparatus 1000 in the first example embodiment.

As illustrated in FIG. 1, the verification apparatus 1000 in the first example embodiment includes a verification unit 1001 that is a specific example of the “verification unit” described in Supplementary Note later, and a correction unit 1002 that is a specific example of the “correction unit” described in Supplementary Note later. The verification unit 1001 extracts a plurality of pieces of first similar data that are registration data similar to query data, from a plurality of pieces of registration data, on the basis of a query feature quantity that is a feature quantity of the query data. The correction unit 1002 corrects the query feature quantity on the basis of statistics of a plurality of registration feature quantities that are feature quantities of the plurality of pieces of first similar data extracted by the verification unit 1001. When the correction unit 1002 corrects the query feature quantity, the verification unit 1001 extracts at least one piece of second similar data that are registration data similar to the query data, from the plurality of pieces of registration data, on the basis of the corrected query feature quantity.

The verification apparatus 1000 in the first example embodiment described above, corrects the query feature quantity on the basis of a result of extraction processing of extracting the registration data similar to the query data, as the first similar data, on the basis of the query feature quantity, and performs verification processing again on the basis of the corrected query feature quantity. As a consequence, verification accuracy of the query data is improved, as compared with a case where the verification processing is not performed again.

### (2) Second Example Embodiment

Next, a verification apparatus, a verification method, and a recording medium in a second example embodiment will be described. The following describes the verification apparatus, the verification method, and the recording medium in the second example embodiment, by using a verification apparatus 1 to which the verification apparatus, the verification method, and the recording medium in the second example embodiment are applied.

### (2-1) Outline of Verification Apparatus 1 in Second Example Embodiment

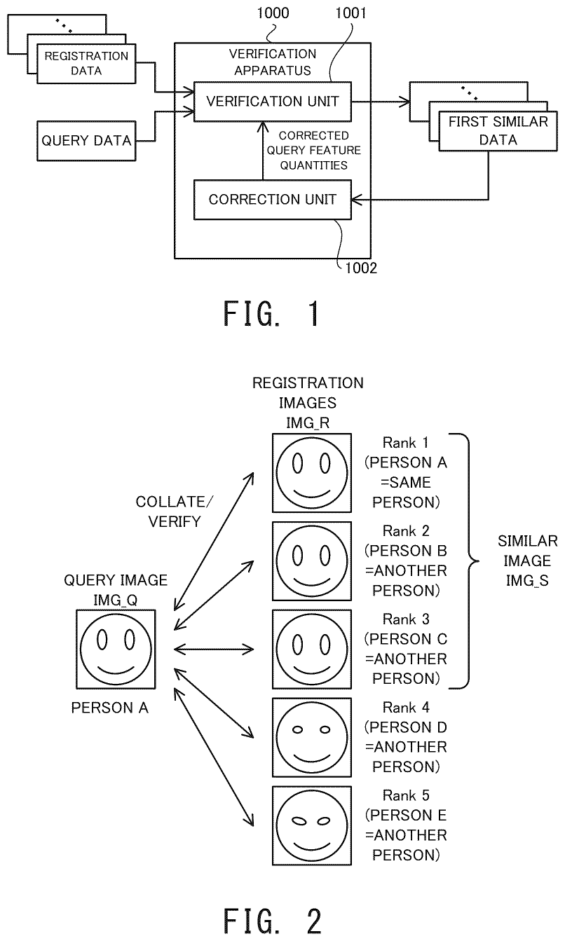

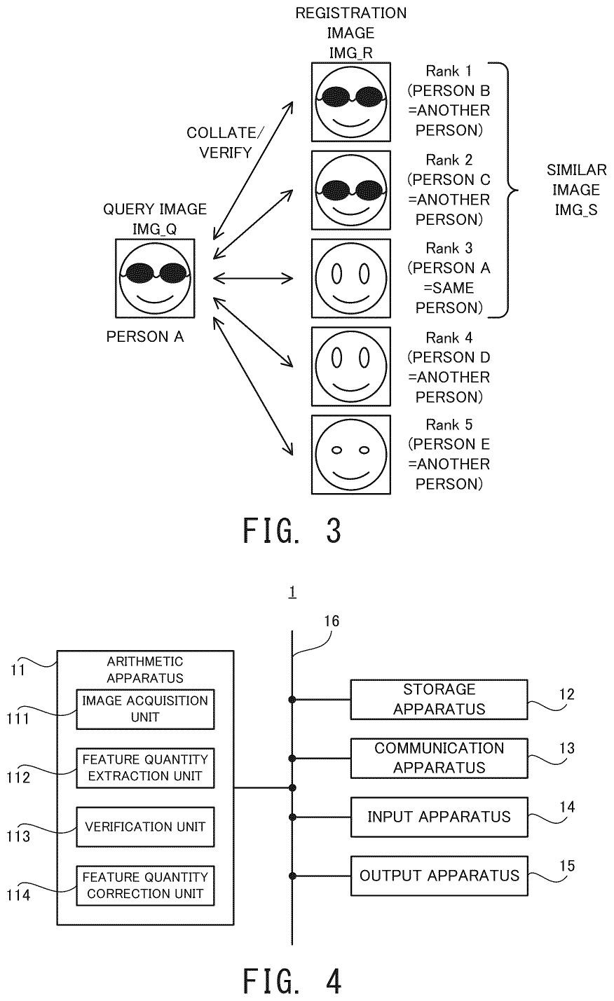

The verification apparatus 1 performs a verification operation of collating/verifying the query image IMG_Q with a plurality of registration images IMG_R, thereby extracting at least one registration image IMG_R similar to the query image IMG_Q, as at least one similar image IMG_S, from the plurality of registration images IMG_R, as illustrated in FIG. 2. Specifically, the verification apparatus 1 performs the verification operation of extracting K similar images IMG_S similar to the query image IMG_Q (where K is a variable indicating an integer of 1 or more). For example, the verification apparatus 1 may extract, as the similar image IMG_S, one registration image IMG_R satisfying an extraction condition that a degree of similarity between one registration image IMG_R extracted as the similar image IMG_S and the query image IMG_Q is greater than a degree of similarity between another registration image IMG_R not extracted as the similar image IMG_S and the query image IMG_Q.

When there is the registration image IMG_R that is the same as the query image IMG_Q, the registration image IMG_R is likely to be extracted as the similar image IMG_S because the degree of similarity between the registration image IMG_R and the query image IMG_Q is relatively high. Therefore, an example of the “registration image IMG_R similar to the query image IMG_Q” in the second example embodiment, includes not only the “registration image IMG_R that is not the same as, but similar to the query image IMG_Q”, but also the “registration image IMG_R that is the same as the query image IMG_Q”.

The second example embodiment especially describes an example in which a face of a person is captured in each of the query image IMG_Q and the plurality of registration images IMG_R, as illustrated in FIG. 2. In the following description, the person included in the query image IMG_Q is referred to as a query person, and the person included in the registration image IMG_R is referred to as a registered person. In this case, the verification operation of extracting, as the similar image IMG_S, the registration image IMG_R similar to the query image IMG_Q, may be considered equivalent to an operation of extracting, as the similar image IMG_S, the registration image IMG_R including a registered person similar to the query person.

The verification apparatus 1 may perform the verification operation to identify a registered person who is the same as the query person (i.e., to perform person verification). Alternatively, the verification apparatus 1 may perform the verification operation to search for a registration image including the query person as the registered person (i.e., to perform an image search).

When there is a registration image IMG_R including the registered person who is the same as the query person, the registration image IMG_R is likely to be extracted as the similar image IMG_S because the degree of similarity between the registration image IMG_R and the query image IMG_Q is relatively high. Therefore, an example of the “registration image IMG_R similar to the query image IMG_Q” in the second example embodiment, includes not only the “registration image IMG_R including the registered person who is not the same as, but similar to the query person”, but also the “registration image IMG_R including the registered person who is the same as the query person”.

### (2-2) Technical Problem to be Solved by Verification Apparatus 1 in Second Example Embodiment

The verification apparatus 1 that performs the verification operation of extracting, as the similar image IMG_S, the registration image IMG_R similar to the query image IMG_Q, has the following technical problems. Hereinafter, the technical problems will be described by using an example in which the query person captured in the query image IMG_Q is a person A, and in which the plurality of registration images IMG_R include five registration images IMG_R in which the person A, a person B, a person C, a person D, and a person E are captured as five registered persons, respectively. In this case, as illustrated in FIG. 2, normally, the verification apparatus 1 may extract, as the similar image IMG_S, the registration image IMG_R including the registered person (person A) who is the same as the query person (person A), and the registration image IMG_R including the registered person who is not the same as, but similar to the query person (person A). For example, FIG. 2 illustrates an example in which the verification apparatus 1 extracts, as the similar image IMG_S, each of the registration image IMG_R including the registered person (person A), the registration image IMG_R including the registered person (person B), and the registration image IMG_R including the registered person (person C). In this case, when the plurality of similar images IMG_S are arranged in order of the degree of similarity, as illustrated in FIG. 2, the similar image IMG_S including the registered person (person A) who is the same as the query person (person A), is normally listed in higher order than the similar image IMG_S including the registered person (person B or person C) who is not the same as the query person (person A). In this case, by the verification operation, the registered person (person A) who is the same as the query person (person A) is extracted as the registered person that is most likely to be the same as the query person (person A). Therefore, it can be said that verification accuracy of the query image IMG_Q is high.

On the other hand, depending on a state of the query person captured in the query image IMG_Q and a state of the registered person captured in the registration image IMG_R, there is a possibility that the similar image IMG_S including the registered person (person B, C, D or E) who is not the same as the query person (person A), is listed in higher order than the similar image IMG_S including the registered person (person A) who is the same as the query person (person A).

As an example, when the registered person who is different from the query person (person A) is wearing the same wearing item as that of the query person (person A), a degree of similarity between the registered person who is different from the query person (person A) and the query person (person A) is higher than that when the registered person who is different from the query person (person A) is not wearing the same wearing item as that of the query person (person A). That is, there is a high degree of similarity between the registration image IMG_R including the registered person who is different from the query person (person A) and the query image IMG_Q. Consequently, there is a possibility that the similar image IMG_S including the registered person (person B, C, D or E) who is not the same as the query person (person A), is listed in higher order than the similar image IMG_S including the registered person (person A) who is the same as the query person (person A).

An example of the wearing item may be at least one of a mask, eyeglasses, sunglasses, and a hat. For example, FIG. 3 illustrates the query image IMG_Q and the registration images IMG_R acquired when the query person (person A) is wearing sunglasses, the registered person (person A) who is the same as the query person (person A) is not wearing sunglasses, the registered person (each of persons B and C) who is different from the query person (person A) is wearing sunglasses, and the registered person (each of persons D and E) who is different from the query person (person A) is not wearing sunglasses. In this case, the degree of similarity between each of the registration images IMG_R (B) and IMG_R (C) including the registered person wearing sunglasses (each of the persons B and C) and the query image IMG_Q, is unintentionally high due to the fact that the query person (person A) is wearing sunglasses. As a consequence, as illustrated in FIG. 3, there is a possibility that the similar image IMG_S including the registered person (each of the persons B and C in the example illustrated in FIG. 3) who is not the same as the query person, is listed in higher order than the similar image IMG_S including the registered person (person A) who is the same as the query person (person A).

As another example, in a situation where a predetermined part of the face of the query person (person A) is hidden by a predetermined obstacle, when a predetermined part of the face of the registered person who is different from the query person (person A) is hidden by the same obstacle, the degree of similarity between the registered person who is different from the query person (person A) and the query person (person A) is higher than that when the predetermined part of the face of the registered person who is different from the query person (person A) is not hidden by the same obstacle in the situation where the predetermined part of the face of the query person (person A) is hidden by the predetermined obstacle. That is, there is a high degree of similarity between the registration image IMG_R including the registered person who is different from the query person (person A) and the query image IMG_Q. Consequently, there is a possibility that the similar image IMG_S including the registered person (person B, C, D or E) who is not the same as the query person, is listed in higher order than the similar image IMG_S including the registered person (person A) who is the same as the query person (person A). An example of the obstacle may be at least one of a hair and a beard.

As another example, in a situation where a predetermined part of the face of the query person (person A) is not captured in the query image IMG_Q, when the same part of the face of the registered person who is different from the query person (person A) is not captured in the registration image IMG_R, the degree of similarity between the registered person who is different from the query person (person A) and the query person (person A) is higher than that when the same part of the face of the registered person who is different from the query person (person A) is captured in the registration image IMG_R in the situation where the predetermined part of the face of the query person (person A) is not captured in the query image IMG_Q. That is, there is a high degree of similarity between the registration image IMG_R including the registered person who is different from the query person (person A) and the query image IMG_Q. Consequently, there is a possibility that the similar image IMG_S including the registered person (person B, C, D or E) who is not the same as the query person, is listed in hither order than the similar image IMG_S including the registered person (person A) who is the same as the query person (person A). One of the reasons why the image does not include the predetermined part of the face of the person, is that a part of the face enters a blind spot of a camera due to the direction of the face to the camera.

As another example, when an imaging condition in the imaging of the query person (person A) is similar to a condition in the imaging of the registered person who is different from the query person (person A), the degree of similarity between the registered person who is different from the query person (person A) and the query person (person A) is higher than that when the imaging condition in the imaging of the query person (person A) is not similar to the condition in the imaging of the registered person who is different from the query person (person A). That is, there is a high degree of similarity between the registration image IMG_R including the registered person who is different from the query person (person A) and the query image IMG_Q. Consequently, there is a possibility that the similar image IMG_S including the registered person (person B, C, D or E) who is not the same as the query person, is listed in hither order than the similar image IMG_S including the registered person (person A) who is the same as the query person (person A). An example of the imaging condition may be at least one of a condition about illumination light for illuminating the query person or the registered person, and a condition about a type of the camera for illuminating the query person or the registered person.

As described above, when the similar image IMG_S including the registered person who is not the same as the query person, is listed in higher order than the similar image IMG_S including the registered person (person A) who is the same as the query person (person A), it can be said that, by the verification operation, the registered person who is not the same as the query person (person A) is extracted as the registered person who is most likely to be the same as the query person (person A). Therefore, it cannot necessarily be said that the verification accuracy of the query image IMG_Q is high.

Therefore, in the second example embodiment, the verification apparatus 1 is configured to solve the above-described technical problems. Specifically, the verification apparatus 1 performs the verification operation to improve the verification accuracy of the query image IMG_Q. Hereinafter, such a verification apparatus 1 will be described in more detail.

### (2-3) Configuration of Verification Apparatus 1

First, with reference to FIG. 4, a configuration of the verification apparatus 1 in the second example embodiment will be described. FIG. 4 is a block diagram illustrating the configuration of the verification apparatus 1 in the second example embodiment.

As illustrated in FIG. 4, the verification apparatus 1 includes an arithmetic apparatus 11, a storage apparatus 12, and a communication apparatus 13. Furthermore, the verification apparatus 1 may include an input apparatus 14 and an output apparatus 15. The verification apparatus 1, however, may not include at least one of the input apparatus 14 and the output apparatus 15. The arithmetic apparatus 11, the storage apparatus 12, the communication apparatus 13, the input apparatus 14, and the output apparatus 15 may be connected through a data bus 16.

The arithmetic apparatus 11 includes at least one of a CPU (Central Processing Unit), a GPU (Graphics Processing Unit), a FPGA (Field Programmable Gate Array), for example. The arithmetic apparatus 11 reads a computer program. For example, the arithmetic apparatus 11 may read a computer program stored in the storage apparatus 12. For example, the arithmetic apparatus 11 may read a computer program stored by a computer-readable and non-transitory recording medium, by using a not-illustrated recording medium reading apparatus provided in the verification apparatus 1. The arithmetic apparatus 11 may acquire (i.e., download or read) a computer program from a not-illustrated apparatus disposed outside the verification apparatus 1, through the communication apparatus 13 (or another communication apparatus). The arithmetic apparatus 11 executes the read computer program. Consequently, a logical functional block for performing an operation to be performed by the verification apparatus 1 (e.g., the above-described verification operation) is realized or implemented in the arithmetic apparatus 11. That is, the arithmetic apparatus 11 is allowed to function as a controller for realizing or implementing the logical functional block for performing an operation (in other words, processing) to be performed by the verification apparatus 1.

FIG. 4 illustrates an example of the logical functional block realized or implemented in the arithmetic apparatus 11 to perform the verification operation. As illustrated in FIG. 4, an image acquisition unit 111, a feature quantity extraction unit 112, a verification unit 113 that is a specific example of the “verification unit” described in Supplementary Note later, and a feature quantity correction unit 114 that is a specific example of the “correction unit” described in Supplementary Note later, are realized or implemented in the arithmetic apparatus 11. The operation of each of the image acquisition unit 111, the feature quantity extraction unit 112, the verification unit 113, and the feature quantity correction unit 114 will be described in detail with reference to FIG. 4 and the like.

The storage apparatus 12 is configured to store desired data. For example, the storage apparatus 12 may temporarily store a computer program to be executed by the arithmetic apparatus 11. The storage apparatus 12 may temporarily store data that are temporarily used by the arithmetic apparatus 11 when the arithmetic apparatus 11 executes the computer program. The storage apparatus 12 may store data that are stored by the verification apparatus 1 for a long time. The storage apparatus 12 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 12 may include a non-transitory recording medium.

The communication apparatus 13 is configured to communicate with an apparatus external to the verification apparatus 1.

The input apparatus 14 is an apparatus that receives an input of information to the verification apparatus 1 from the outside of the verification apparatus 1. For example, the input apparatus 14 may include an operating apparatus (e.g., at least one of a keyboard, a mouse, and a touch panel) that is operable by an operator of the verification apparatus 1. For example, the input apparatus 14 may include a reading apparatus that is configured to read information recorded as data on a recording medium that is externally attachable to the verification apparatus 1.

The output apparatus 15 is an apparatus that outputs information to the outside of the verification apparatus 1. For example, the output apparatus 15 may output information as an image. That is, the output apparatus 15 may include a display apparatus (a so-called display) that is configured to display an image indicating the information that is desirably outputted. For example, the output apparatus 15 may output information as audio/sound. That is, the output apparatus 15 may include an audio apparatus (a so-called speaker) that is configured to output the audio/sound. For example, the output apparatus 15 may output information onto a paper surface. That is, the output apparatus 15 may include a print apparatus (a so-called printer) that is configured to print desired information on the paper surface.

### (2-4) Verification Operation Performed by Verification Apparatus 1

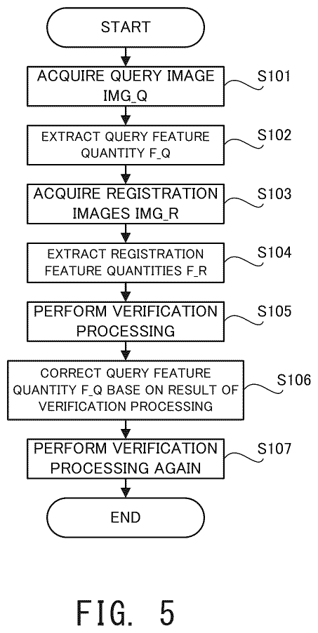

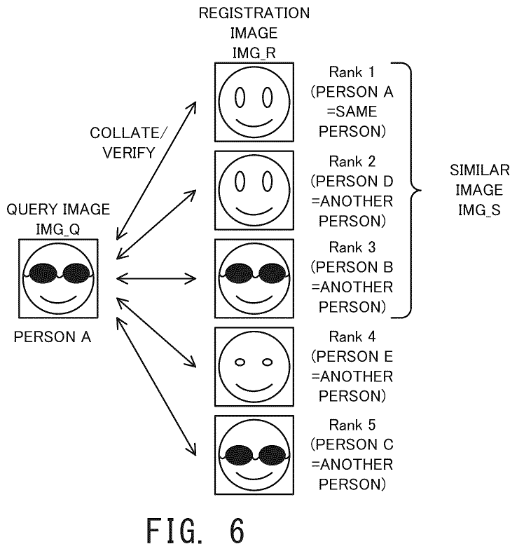

Next, with reference to FIG. 5, the verification operation performed by the verification apparatus 1 in the second example embodiment will be described. FIG. 5 is a flowchart illustrating a flow of the verification operation performed by the verification apparatus 1 in the second example embodiment.

As illustrated in FIG. 5, the image acquisition unit 111 acquires the query image IMG_Q (step S101). For example, when the query image IMG_Q is generated by a camera that images the query person, the image acquisition unit 111 may acquire the query image IMG_Q from the camera, by using the communication apparatus 13. For example, when the query image IMG_Q is stored by an apparatus external to the verification apparatus 1, the image acquisition unit 111 may acquire the query image IMG_Q from the apparatus external to the verification apparatus 1, by using the communication apparatus 13. For example, when the query image IMG_Q is stored by the storage apparatus 12, the image acquisition unit 111 may acquire the query image IMG_Q from the storage apparatus 12.

Thereafter, the feature quantity extraction unit 112 extracts a query feature quantity F_Q that is a feature quantity of the query image IMG_Q (step S102). Specifically, the feature quantity extraction unit 112 extracts a feature quantity of the query person captured in the query image IMG_Q, as the query feature quantity F_Q. For example, when the face of the query person is captured in the query image IMG_Q, the feature quantity extraction unit 112 may extract a feature quantity of the face of the query person, as the query feature quantity F_Q.

In parallel with or in reverse order of the step S101 to the step S102, the image acquisition unit 111 acquires a plurality of registration images IMG_R (step S103). For example, when the plurality of registration images IMG_R are stored by an apparatus external to the verification apparatus 1, the image acquisition unit 111 may acquire the plurality of registration images IMG_R from the apparatus external to the verification apparatus 1, by using communication apparatus 13. For example, when the plurality of registration images IMG_R are stored by the storage apparatus 12, the image acquisition unit 111 may acquire the plurality of registration images IMG_R from the storage apparatus 12.

Thereafter, the feature quantity extraction unit 112 extracts a registration feature quantity F_R that is a feature quantity of each of the plurality of registration images IMG_R (step S104). That is, the feature quantity extraction unit 112 extracts a plurality of registration feature quantities F_R corresponding to the plurality of registration images IMG_R, respectively. Specifically, the feature quantity extraction unit 112 extracts a feature quantity of the registered person captured in the registration image IMG_R as the registration feature quantity F_R. For example, when the face of the registered person is captured in the registration image IMG_R, the feature quantity extraction unit 112 may extract a feature quantity of the face of the registered person as the registration feature quantity F_R.

When the apparatus external to the verification apparatus 1 or the storage apparatus 12 stores the plurality of registration feature quantities F_R respectively corresponding to the plurality of registration images IMG_R in addition to or instead of the plurality of registration images IMG_R, in the step S103, the image acquisition unit 111 may acquire the plurality of registration feature quantities F_R in addition to or instead of the plurality of registration images IMG_R. In this instance, in the step S104, the feature quantity extraction unit 112 may not extract the plurality of registration feature quantities F_R.

Thereafter, the verification unit 113 performs the verification operation of extracting K registration images IMG_R similar to the query image IMG_Q, as K similar images IMG_S, from the plurality of registration images IMG_R acquired in the step S103, on the basis of the query feature quantity F_Q extracted in the step S102 (step S105). Especially in the step S105, the verification unit 113 performs the verification processing of extracting a plurality of similar images IMG_S. That is, in the step S105, the variable K indicating the number of the similar images IMG_S extracted by the verification processing, is an integer of 2 or more.

In order to extract the K similar images IMG_S in the step S105, the verification unit 113 collates/verifies the query feature quantity F_Q extracted in the step S102 with the plurality of registration feature quantities F_R extracted in the step S104. Specifically, the verification unit 113 calculates a degree of similarity between the query feature quantity F_Q and each of the plurality of registration feature quantities F_R. As the degree of similarity increases between the query feature quantity F_Q and the registration feature quantity F_R, the degree of similarity increases between the query image IMG_Q and the registration image IMG_R. Therefore, the degree of similarity between the query feature quantity F_Q and the registration feature quantity F_R is equivalent to the degree of similarity between the query image IMG_Q and the registration image IMG_R. In other words, as the degree of similarity increases between the query feature quantity F_Q and the registration feature quantity F_R, the degree of similarity increases between the query person captured in the query image IMG_Q and the registered person captured in the registration image IMG_R. Therefore, the degree of similarity between the query feature quantity F_Q and the registration feature quantity F_R is equivalent to the degree of similarity between the query person and the registered person.

Thereafter, the verification unit 113 extracts the K similar images IMG_S on the basis of the calculated degree of similarity. For example, the verification unit 113 may extract the K similar images IMG_S with a relatively high degree of similarity. That is, the verification unit 113 may extract the K similar images IMG_S in descending order of the degree of similarity. In other words, the verification unit 113 may extract, as the K similar images IMG_S, the K registration images IMG_R satisfying an extraction condition that the degree of similarity between each of the K registration images IMG_R extracted as the similar images IMG_S and the query image IMG_Q is greater than the degree of similarity between the remaining registration image(s) IMG_R extracted as the similar image(s) IMG_S and the query image IMG_Q.

Thereafter, the feature quantity correction unit 114 corrects the query feature quantity F_Q extracted in the step S102 on the basis of a result of the verification processing in the step S105 (step S106). As a result, the feature quantity correction unit 114 generates a new query feature quantity F_Q corresponding to the corrected query feature quantity F_Q. In the following description, the query feature quantity F_Q corrected in the step S106 is referred to as a “query feature quantity F_Q_correct” to distinguish it from the query feature quantity F_Q that is not corrected in the step S106 (i.e., the query feature quantity F_Q extracted in the step S102).

In the second example embodiment, the feature quantity correction unit 114 corrects the query feature quantity F_Q on the basis of K registration feature quantities F_R respectively corresponding to the K similar images IMG_S (i.e., the K registration images IMG_R) in the step S105. Specifically, the feature quantity correction unit 114 calculates an arithmetic value AV of the K registration feature quantities F_R by a predetermined arithmetic operation, and corrects the query feature quantity F_Q on the basis of the calculated arithmetic value AV.

The registration feature quantity F_R is usually expressed as a M-dimensional feature quantity vector (where M is a variable indicating an integer of 1 or more). In this instance, the feature quantity correction unit 114 may calculate a vector arithmetic value of K feature quantity vectors respectively representing the K registration feature quantities F_R, as the arithmetic value AV.

The arithmetic value AV may be an index value indicating a feature quantity component common to at least two of the K similar images IMG_S. In other words, the arithmetic value AV may be an index value indicating a feature quantity component common to at least two of K registered persons who are respectively captured in the K similar images IMG_S. To put it differently, the arithmetic value AV may be an index value indicating a feature quantity component common to at least two of the K registration feature quantities F_R. The arithmetic value AV may be an index value in which the feature quantity component common to at least two of the K similar images IMG_S is reflected more significantly than a feature quantity component characteristic of each of the K similar images IMG_S. In other words, the arithmetic value AV may be an index value in which the feature quantity component common to at least two of the K registered persons respectively captured in the K similar images IMG_S is reflected more significantly than a feature quantity component characteristic of each of the K registered persons respectively captured in the K similar images IMG_S. To put it differently, the arithmetic value AV may be an index value in which the feature quantity component common to at least two of the K registration feature quantities F_R is reflected more significantly than a feature quantity component characteristic of each of the K registration feature quantities F_R. The arithmetic value AV may be an index value in which the feature quantity component common to at least two of the K similar images IMG_S is a main feature quantity component. In other words, the arithmetic value AV may be an index value in which the feature quantity component common to at least two of the K registered persons respectively captured in the K similar images IMG_S is a main feature quantity component. To put it differently, the arithmetic value AV may be an index value in which the feature quantity component common to at least two of the K registration feature quantities F_R is a main feature quantity component.

An example of such an arithmetic value AV may be a simple average value (e.g., vector average). In this instance, the feature quantity correction unit 114 may calculate a simple average value of the K registration feature quantities F_R as the arithmetic value AV. The simple average value of K registration feature quantities F_R, includes a relatively large amount of feature quantity component common to at least two of the K registration feature quantities F_R. On the other hand, in the simple average value of the K registration feature quantities F_R, a norm of the feature quantity component characteristic of each of the K registration feature quantities F_R is reduced by averaging. As a result, the simple average value of the K registration feature quantities F_R is an index value in which the feature quantity component common to at least two of the K registration feature quantities F_R is reflected more significantly than the feature quantity component characteristic of each of the K registration feature quantities F_R.

As an example, in the example illustrated in FIG. 3, in a situation where the query person (person A) is wearing sunglasses, the registration image IMG_R (A) including the registered person (person A) who is the same as the query person (person A), but is not wearing sunglasses, the registration image IMG_R (B) including the registered person (person B) who is not the same as the query person (person A), but is wearing sunglasses, and the registration image IMG_R (C) including the registered person (person C) who is not the same as the query person (person A), but is wearing sunglasses, are extracted as the similar images IMG_S. In this case, the feature quantity correction unit 114 calculates, as the arithmetic value AV, a simple average value of the registration feature quantity F_R of the registration image IMG_R (A), the registration feature quantity F_R of the registration image IMG_R (B), and the registration feature quantity F_R of the registration image IMG_R (C). In this case, the arithmetic value AV is an index value in which a feature quantity component related to the sunglasses common to two of the three registration feature quantities F_R is reflected more significantly than a feature quantity component that is different from the feature quantity component related to the sunglasses. That is, the arithmetic value AV is an index value in which the feature quantity component related to the sunglasses common to two of the three registration feature quantities F_R is a main feature quantity component.

In the example illustrated in FIG. 3, it can be said that the arithmetic value AV is an index value in which a feature quantity component related to an area including the sunglasses common to two of the three registration feature quantities F_R is a main feature quantity component. In this instance, the arithmetic value AV may be regarded as an index value in which a feature quantity component of a particular area of each of the K similar images IMG_S is reflected more significantly than a feature quantity component of an area other than the particular area of each of the K similar images IMG_S. In the example illustrated in FIG. 3, the arithmetic value AV may be regarded as an index value in which a feature quantity component of an eye area (i.e., an eye area including the sunglasses) of each of the K similar images IMG_S is reflected more significantly than a feature quantity component of an area other than the eye area of each of the K similar images IMG_S. Therefore, the arithmetic value AV may be an index value in which the feature quantity component of the particular area of each of the K similar images IMG_S is reflected more significantly than the feature quantity component of the area other than the particular area of each of the K similar images IMG_S.

Furthermore, in the example illustrated in FIG. 3, it can be said that the arithmetic value AV is an index value in which a feature quantity component related to an object that is sunglasses common to two of the three registration feature quantities F_R is a main feature quantity component. Therefore, the arithmetic value AV may be an index value in which a feature quantity component of a particular object common to at least two of the K similar images IMG_S is reflected more significantly than a feature quantity component of an object other than the particular object in each of the K similar images IMG_S.

After the arithmetic value AV is calculated, the feature quantity correction unit 114 performs an arithmetic operation of subtracting the calculated arithmetic value AV from the query feature quantity F_Q extracted in the step S102, thereby generating the query feature quantity F_Q_correct. That is, the feature quantity correction unit 114 generates the query feature quantity F_Q_correct (i.e., corrects the query feature quantity F_Q) by using an equation of “Query feature quantity F_Q_correct=Query feature quantity F_Q-Arithmetic value AV”.

Here, as described above, the arithmetic value AV is an index value in which the feature quantity component common to at least two of the K registration feature quantities F_R is a min feature quantity component. In this case, the arithmetic operation of subtracting the arithmetic value AV from the query feature quantity F_Q may be regarded as an arithmetic operation of subtracting the feature quantity component common to at least two of the K registration feature quantities F_R, from the query feature quantity F_Q. As a consequence, the arithmetic operation of subtracting the arithmetic value AV from the query feature quantity F_Q may be considered to be substantially equivalent to an arithmetic operation of lowering a degree of contribution to the query feature quantity F_Q of the feature quantity component common to at least two of the K registration feature quantities F_R. Consequently, a degree of contribution of the feature quantity component common to at least two of the K registration feature quantities F_R with respect to the corrected query feature quantity F_Q_correct, is less than a degree pf contribution of the feature quantity component common to at least two of the K registration feature quantities F_R with respect to the query feature quantity F_Q that is not corrected. In the example illustrated in FIG. 3, the arithmetic operation of subtracting the arithmetic value AV from the query feature quantity F_Q may be considered to be substantially equivalent to the arithmetic operation of lowering a degree of contribution of the feature quantity component of the sunglasses to the query feature quantity F_Q. Consequently, a degree of contribution of the feature quantity component of the sunglasses to the corrected query feature quantity F_Q_correct is less than a degree of contribution of the feature quantity component of the sunglasses to the query feature quantity F_Q that is not corrected.

Thereafter, the verification unit 113 performs the verification processing of extracting the K similar images IMG_S similar to the query image IMG_Q, from the plurality of registration images IMG_R acquired in the step S103, on the basis of the query feature quantity F_Q_correct corrected in the step S106 (step S107). Especially in the step S107, the verification unit 113 performs the verification processing of extracting at least one similar image IMG_S. That is, in the step S107, the variable K indicating the number of the similar images IMG_S extracted by the verification processing is an integer of 1 or more.

In order to extract the K similar images IMG_S in the step S107, the verification unit 113 calculates a degree of similarity between the query feature quantity F_Q_correct extracted in the step S106 and each of the plurality of registration feature quantities F_R extracted in the step S104. Thereafter, the verification unit 113 extracts the K similar images IMG_S on the basis of the calculated degree of similarity. For example, the verification unit 113 may extract the K similar images IMG_S with a relatively high degree of similarity. That is, the verification unit 113 may extract the K similar images IMG_S in descending order of the degree of similarity. In other words, the verification unit 113 may extract, as the K similar images IMG_S, the K registration images IMG_R satisfying the extraction condition that the degree of similarity between each of the K registration images IMG_R extracted as the similar images IMG_S and the query image IMG_Q is greater than the degree of similarity between the remaining registration image(s) IMG_R extracted as the similar image(s) IMG_S and the query image IMG_Q.

Here, one of the reasons for the above-described technical problem that “the similar image IMG_S including the registered person who is not the same as the query person is listed in higher order than the similar image IMG_S including the registered person who is the same as the query person”, is that the verification processing is performed by using the query feature quantity F_Q with a high degree of contribution of the feature quantity component common to at least two of the K registration feature quantities F_R. For example, in the example illustrated in FIG. 3, one of the reasons for the technical problem that “the similar image IMG_S including the registered person who is not the same as the query person wearing sunglasses, but is wearing sunglasses, is listed in higher order than the similar image IMG_S including the registered person who is the same as the query person wearing sunglasses, but is not wearing sunglasses”, is that the verification processing is performed by using the query feature quantity F_Q with a high degree of contribution of the feature quantity component of the sunglasses common to at least two of the K registration feature quantities F_R.

On the other hand, in the second example embodiment, the degree of contribution of the feature quantity component common to at least two of the K registration feature quantities F_R with respect to the corrected query feature quantity F_Q_correct is relatively small. In the example illustrated in FIG. 3, the degree of contribution of the feature quantity component of the sunglasses to the corrected query feature quantity F_Q_correct is relatively small. Therefore, it can be said that the degree of similarity between the query feature quantity F_Q_correct and the registration feature quantity F_R is a degree of similarity related to a feature quantity component that different from the feature quantity component common to at least two of the K registration feature quantities F_R. In the example illustrated in FIG. 3, it can be said that the degree of similarity between the query feature quantity F_Q_correct and the registration feature quantity F_R is a degree of similarity related to a feature quantity component that is different from the feature quantity component of the sunglasses. Then, when the verification processing is performed by using the query feature quantity F_Q_correct with a low degree of contribution of the feature quantity component common to at least two of the K registration feature quantities F_R, it is less likely that the similarity image IMG_S including the registered person who is not the same as the query person is listed in higher order than the similar image IMG_S including the registered person who is the same as the query person, as compared with a case where the verification processing is performed by using the query feature quantity F_Q with a high degree of contribution of the feature quantity component common to at least two of the K registration feature quantities F_R.

In the example illustrated in FIG. 3, since the verification processing is performed by using the query feature quantity F_Q_correct with a low degree of contribution of the feature quantity component of the sunglasses, the order of the degree of similarity of the registration image IMG_R including the registered person who is not the same as the query person wearing sunglasses, but is wearing sunglasses, is expectedly lowered. Specifically, when the verification processing is performed by using the query feature quantity F_Q with a high degree of contribution of the feature quantity component of the sunglasses, as illustrated in FIG. 3, the similar image IMG_S including the registered person (person B or C) who is not the same as the query person (person A) wearing sunglasses, but is wearing sunglasses, is listed in relatively high order. On the other hand, when the verification processing is performed by using the query feature quantity F_Q_correct with a low degree of contribution of the feature quantity component of the sunglasses, as illustrated in FIG. 6, it is less likely that the similar image IMG_S including the registered person (person B or C) who is not the same as the query person (person A) wearing sunglasses, but is wearing sunglasses, is listed in relatively high order. As a consequence, when the verification processing is performed by using the query feature quantity F_Q_correct with a low degree of contribution of the feature quantity component of the sunglasses, it is less likely that the similar image IMG_S including the registered person who is not the same as the query person wearing sunglasses, but is wearing sunglasses, is listed in higher order than the similar image IMG_S including the registered person who is the same as the query person wearing sunglasses, but is not wearing sunglasses, as compared with a case where the verification processing is performed by using the query feature quantity F_Q with a high degree of contribution of the feature quantity component of the sunglasses. Therefore, the verification accuracy of the query image IMG_Q is improved.

As described above, in the second example embodiment, the degree of similarity between the registration feature quantity F_R of the registration image IMG_R including the registered person who is not the same as the query person and the query feature quantity F_Q_correct, is less than the degree of similarity between the registration feature quantity F_R including the registered person who is not the same as the query person and the query feature quantity F_Q. As a consequence, when the verification processing is performed by using the query feature quantity F_Q_correct, the order of the degree of similarity of the registration image IMG_R including the registered person who is not the same as the query person, is expectedly lowered, as compared with a case where the verification processing is performed by using the query feature quantity F_Q. As a consequence, it is less likely that the similar image IMG_S including the registered person who is not the same as the query person, is listed in higher order than the similar image IMG_S including the registered person who is the same as the query person. Therefore, the verification accuracy of the query image IMG_Q is improved.

### (2-5) Technical Effect of Verification Apparatus 1 in Second Example Embodiment

As described above, the verification apparatus 1 calculates a new query feature quantity F_Q_correct by correcting the query feature quantity F_Q on the basis of the result of the verification processing using the query feature quantity F_Q, and performs the verification processing again on the basis of the new query feature quantity F_Q_correct. As a consequence, the verification accuracy of the query image F_Q is improved, as compared with a case where the verification processing is not performed again on the basis of the new query feature quantity F_Q_correct.

In the second example embodiment, in order to correct the query feature quantity F_Q, the feature quantity correction unit 114 subtracts the arithmetic value AV from the query feature quantity F_Q. Therefore, as described above, the feature quantity correction unit 114 is capable of properly generating the query feature quantity F_Q_correct with a relatively low degree of contribution of the feature quantity component common to at least two of the K registration feature quantities F_R. Consequently, the verification accuracy of the query image F_Q is improved.

In the second example embodiment, in order to correct the query feature quantity F_Q, the feature quantity correction unit 114 calculates the simple average value of the K registration feature quantities F_R, as the arithmetic value AV. Therefore, as described above, the feature quantity correction unit 114 is capable of properly generating the query feature quantity F_Q_correct having a relatively low degree of contribution of the feature quantity component common to at least two of the K registration feature quantities F_R. Consequently, the verification accuracy of the query image F_Q is improved.

### (2-6) Modified Examples

In the above description, the feature quantity correction unit 114 calculates the simply average value of the K registration feature quantities F_R as the arithmetic value AV. The feature quantity correction unit 114, however, may calculate another type of average/mean value of the K registration feature quantities F_R as the arithmetic value AV. For example, the feature quantity correction unit 114 may calculate a weighted average/mean value of the K registration feature quantities F_R as the arithmetic value AV. As an example, the feature quantity correction unit 114 may calculate, as the arithmetic value AV, the weighted average/mean value of the K registration feature quantities F_R in which the order of the K registration feature quantities F_R (specifically, the order corresponding to the degree of similarity calculated by the verification processing) is used as a weight. Specifically, the feature quantity correction unit 114 may calculate, as the arithmetic value AV, the weighted average/mean value of the K registration feature quantities F_R using the weight that increases in higher order (i.e., with a higher degree of similarity).

Alternatively, the feature quantity correction unit 114 may calculate the arithmetic value AV that is different from the average/mean value. An example of the arithmetic value AV that is different from the average/mean value, may be at least one of a maximum value of the K registration feature quantities F_R, a minimum value of the K registration feature quantities F_R, and a median value of the K registration feature quantities F_R. The point is, as described above, any arithmetic value may be used as the arithmetic value AV as long as the arithmetic value AV indicates the feature quantity component common to at least two of the K registration images IMG_R respectively extracted as the K similar images IMG_S.

In the above description, the feature quantity correction unit 114 generates the query feature quantity F_Q_correct by performing the arithmetic operation of subtracting the arithmetic value AV from the query feature quantity F_Q. The feature quantity correction unit 114, however, may generate the query feature quantity F_Q_correct by performing an arithmetic operation that is different from the arithmetic operation of subtracting the arithmetic value AV from the query feature quantity F_Q. For example, the feature quantity correction unit 114 may generate the query feature quantity F_Q_correct by performing any arithmetic operation using the arithmetic value AV. Considering that the reason for performing the arithmetic operation of subtracting the value AV from the query feature quantity F_Q is to lower the degree of contribution of the feature quantity component common to at least two of the K registration feature quantities F_R with respect to the query feature quantity F_Q, the feature quantity correction unit 114 may generate the query feature quantity F_Q_correct by performing any arithmetic operation capable of lowering the degree of contribution of the feature quantity component common to at least two of the K registration feature quantities F_R with respect to the query feature quantity F_Q.

In the above description, the verification apparatus 1 extracts, as the K similar images IMG_S, the K registration images IMG_R including the registered person similar to the query person captured in the query image IMG_Q, by collating/verifying the query image IMG_Q including the query person with the plurality of registration images IMG_R respectively including the plurality of registered persons. The verification apparatus 1, however, may extract as the K similar images IMG_S, the K registration images IMG_R including a registered object similar to a query object captured in the query image IMG_Q, by collating/verifying the query image IMG_Q including any query object that is different from a person with the plurality of registration images IMG_R respectively including a plurality of registered objects that are different from persons. In this situation, the verification apparatus 1 may perform the verification operation to search for the registration image including the query object as the registered object (i.e., to perform an image search). Even in this case, it is less likely that the similar image IMG_S including the registered object that is not the same as the query object, is listed in higher order than the similar image IMG_S including the registered object that is the same as the query object. Therefore, the verification accuracy of the query image IMG_Q is improved.

Alternatively, the verification apparatus 1 may extract, as K pieces of similar data, K pieces of registration data similar to the query data, by collating/verifying any query data that are different from an image with a plurality of pieces of registration data that are different from an image. In this instance, the verification apparatus 1 may perform the verification operation to search for the registration data that are the same as (or similar to) to the query data (i.e., to perform a data search). Even in this case, it is less likely that the registration data that are not the same as the query data, are listed in higher order than the registration data that are the same as the query data. Therefore, the verification accuracy of the query data is improved.

Each of the query data and the registration data may be text data indicating text (i.e., sentence data). In this situation, the verification apparatus 1 may extract, as the K pieces of similar data, K pieces of registration data indicating registered text similar to query text indicated by the query data. In this instance, the verification apparatus 1 may perform the verification operation to search for the registration data indicating the registered text that is the same as (or similar to) the query text (i.e., to perform a text search). Even in this case, it is less likely that registration data indicating the registered text that is not the same as the query text, is listed in higher order than the registration data indicating the registered text that is the same as the query text. Therefore, verification accuracy of text data is improved.

Each of the query data and the registration data may be voice data indicating voice/sound. In this case, the verification apparatus 1 may extract, as the K pieces of similar data, K pieces of registration data indicating registered voice similar to query voice indicated by the query data. In this instance, the verification apparatus 1 may perform the verification operation to search for the registration data indicating the registered voice that is the same as (or similar to) the query voice (i.e., to perform a voice search). Even in this case, it is less likely that the registration data indicating the registered voice that is not the same as the query voice, is listed in higher order than the registration data indicating the registered voice that is the same as the query voice. Therefore, verification accuracy of voice data improved.

### (3) Supplementary Notes

With respect to the example embodiments described above, the following Supplementary Notes are further disclosed.

### [Supplementary Note 1]

A verification apparatus including:
a verification unit that extracts a plurality of pieces of first similar data similar to query data, from a plurality of pieces of registration data, on the basis of a query feature quantity that is a feature quantity of the query data; and
a correction unit that corrects the query feature quantity on the basis of an arithmetic value of a plurality of registration feature quantities that are feature quantities of the plurality of pieces of first similar data, wherein
the verification unit extracts at least one piece of second similar data similar to the query data, from the plurality of pieces of registration data, on the basis of the query feature quantity corrected by the correction unit.

### [Supplementary Note 2]

The verification apparatus according to Supplementary Note 1, wherein the correction unit corrects the query feature quantity by subtracting the arithmetic value of the registration feature quantities of the plurality of pieces of similar data from the query feature quantity.

### [Supplementary Note 3]

The verification apparatus according to Supplementary Note 1 or 2, wherein the arithmetic value includes an average value.

### [Supplementary Note 4]

The verification apparatus according to any one of Supplementary Notes 1 to 3, wherein
the query data include query image data in which a query person is captured,
the query feature quantity includes a feature quantity of the query person,
each of the plurality of pieces of registration data includes registration image data in which a registered person is captured, and
the registration feature quantity includes a feature quantity of the registered person.

### [Supplementary Note 5]

A verification method including:
extracting a plurality of pieces of first similar data similar to query data, from a plurality of pieces of registration data, on the basis of a query feature quantity that is a feature quantity of the query data;
correcting the query feature quantity on the basis of an arithmetic value of a plurality of registration feature quantities that are feature quantities of the plurality of pieces of first similar data; and
extracting at least one piece of second similar data similar to the query data, from the plurality of pieces of registration data, on the basis of the query feature quantity corrected.

### [Supplementary Note 6]

A recording medium on which a computer program that allows a computer to execute a verification method is recorded, the verification method including:
extracting a plurality of pieces of first similar data similar to query data, from a plurality of pieces of registration data, on the basis of a query feature quantity that is a feature quantity of the query data;
correcting the query feature quantity on the basis of an arithmetic value of a plurality of registration feature quantities that are feature quantities of the plurality of pieces of first similar data; and
extracting at least one piece of second similar data similar to the query data, from the plurality of pieces of registration data, on the basis of the query feature quantity corrected.

At least a part of the constituent components of each of the example embodiments described above can be combined with at least another part of the constituent components of each of the example embodiments described above, as appropriate. A part of the constituent components of each of the example embodiments described above may not be used. Furthermore, to the extent permitted by law, all the references (e.g., publications) cited in this disclosure are incorporated by reference as a part of the description of this disclosure.

This disclosure is permitted to be changed, if desired, without departing from the essence or spirit of this disclosure which can be read from the claims and the entire identification. A verification apparatus, a verification method, and a recording medium with such changes are also intended to be in the technical scope of this disclosure.

### DESCRIPTION OF REFERENCE CODES

1 Verification apparatus
11 The arithmetic apparatus
111 Image acquisition unit
112 Feature quantity extraction unit
113 Verification unit
114 Feature quantity correction unit
1000 Verification apparatus
1001 Verification unit
1002 Correction unit
IMG_Q Query image
IMG_R Registration image
IMG_S Similar image
F_Q Query feature quantity
F_R Registration feature quantity

What is claimed is:

1. A verification apparatus comprising:
at least one memory configured to store instructions; and
at least one processor configured to execute the instructions to:
extract a plurality of pieces of first similar data similar to query data, from a plurality of pieces of registration data, on the basis of a query feature quantity that is a feature quantity of the query data; and
correct the query feature quantity on the basis of an arithmetic value of a plurality of registration feature quantities that are feature quantities of the plurality of pieces of first similar data, wherein
the at least one processor configured to execute the instructions to extract at least one piece of second similar data similar to the query data, from the plurality of pieces of registration data, on the basis of the query feature quantity corrected by the correction unit.

2. The verification apparatus according to claim 1, wherein the at least one processor configured to execute the instructions to correct the query feature quantity by subtracting the arithmetic value of the registration feature quantities of the plurality of pieces of similar data from the query feature quantity.

3. The verification apparatus according to claim 1, wherein the arithmetic value includes an average value.

4. The verification apparatus according to claim 1, wherein
the query data include query image data in which a query person is captured,
the query feature quantity includes a feature quantity of the query person,
each of the plurality of pieces of registration data includes registration image data in which a registered person is captured, and
the registration feature quantity includes a feature quantity of the registered person.

5. A verification method comprising:
extracting a plurality of pieces of first similar data similar to query data, from a plurality of pieces of registration data, on the basis of a query feature quantity that is a feature quantity of the query data;
correcting the query feature quantity on the basis of an arithmetic value of a plurality of registration feature quantities that are feature quantities of the plurality of pieces of first similar data; and
extracting at least one piece of second similar data similar to the query data, from the plurality of pieces of registration data, on the basis of the query feature quantity corrected.

6. A non-statutory recording medium on which a computer program that allows a computer to execute a verification method is recorded, the verification method including:
extracting a plurality of pieces of first similar data similar to query data, from a plurality of pieces of registration data, on the basis of a query feature quantity that is a feature quantity of the query data;
correcting the query feature quantity on the basis of an arithmetic value of a plurality of registration feature quantities that are feature quantities of the plurality of pieces of first similar data; and
extracting at least one piece of second similar data similar to the query data, from the plurality of pieces of registration data, on the basis of the query feature quantity corrected.
